(19) United States
(12) Patent Application Publication
(10) Pub. No.: US 2024/0005330 A1
(43) Pub. Date: Jan. 4, 2024

(54) TRANSACTION HEALTH MONITORING AND FAULT-TOLERANT ROUTING

(71) Applicant: BillGO, Inc., Fort Collins, CO (US)

(72) Inventors: Kelly Seidl, Fort Collins, CO (US); Matthew Gordon, Fort Collins, CO (US); Paul Cesario, Fort Collins, CO (US); Steve Kaufman, Fort Collins, CO (US); Sahan Jayasumana, Fort Collins, CO (US)

(21) Appl. No.: 17/809,881

(22) Filed: Jun. 29, 2022

(51) Int. Cl. G06Q 20/40; G06Q 20/02

(52) U.S. Cl. CPC G06Q 20/405; G06Q 20/02

(57) ABSTRACT

The likelihood of a successful transaction may vary according to associated variables (e.g., time of day, day of week or month, proxy or API used, etc.) and/or depending on the transaction route that is used. Accordingly, success rates may be generated for transaction routes using associated variables, which may be used to update rules relating to transaction routing. In addition, fault-tolerant routing may be used to ensure that a transaction ultimately succeeds even if a first or even a second transaction attempt fails. Rules may be used to ensure that customer guarantees are satisfied (e.g., that the transaction is completed on time or by a specified due date), that additional information is requested from the customer as needed (e.g., as may be required by an alternative payment method), and that the customer remains apprised of the status of his or her payments.

### BACKGROUND

Different transaction routes may have different characteristics. For example, a transaction performed according to one transaction route may be completed more quickly as compared to another transaction performed according to another transaction route. Additionally, the likelihood of success may vary according to transaction route, a user associated with the transaction, and/or a recipient associated with the transaction, among other examples.

However, such variability may negatively affect a user's experience, result in user confusion, or may even cause a user to be unable to transact with a recipient in a timely manner, potentially resulting in frustration, delayed transactions, and penalties, among other detriments.

It is with respect to these and other general considerations that embodiments have been described. Also, although relatively specific problems have been discussed, it should be understood that the embodiments should not be limited to solving the specific problems identified in the background.

### SUMMARY

The likelihood of a successful transaction may vary according to associated variables (e.g., time of day, day of week or month, browser user agent, the company that is registered or otherwise associated with a phone number or domain, proxy or API used, etc.) and/or depending on the transaction route that is used (e.g., whether the transaction route is anonymized, has an associated fingerprint, and/or associates the transaction with a given transaction platform). Accordingly, success rates may be generated for transaction routes using associated variables. The success rates may be used to update rules relating to transaction routing. As a result, transaction success may be improved in response to network changes or, as another example, transactions may be scheduled or otherwise performed in a way that increases or maximizes the likelihood of success. In addition, fault-tolerant routing may be used to ensure that a transaction ultimately succeeds even if a first or even a second transaction attempt fails. Rules may be used to ensure that customer guarantees are satisfied (e.g., that the transaction is completed on time or by a specified due date), that additional information is requested from the customer as needed (e.g., as may be required by an alternative payment method), and that the customer remains apprised of the status of his or her payments.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an overview of an example system for transaction health monitoring and fault-tolerant routing.

FIG. 2 illustrates an overview of an example method for evaluating transaction health and adapting transaction rules and associated transaction routes according to aspects of the present disclosure.

FIG. 3 illustrates an overview of an example method for linking with a transaction recipient to facilitate transactions between a user and the transaction recipient.

FIG. 4 illustrates an overview of an example method for synchronizing data from a transaction recipient.

FIG. 5 illustrates an overview of an example method for processing a transaction with a transaction recipient based on a user indication.

FIG. 6 illustrates an overview of an example method for processing a transaction according to aspects described by FIG. 7A, 7B, or 7C.

FIG. 7A illustrates an overview of an example method for processing a scheduled transaction according to aspects of the present disclosure.

FIG. 7B illustrates an overview of another example method for processing a scheduled transaction according to aspects of the present disclosure.

FIG. 7C illustrates an overview of another example method for processing a scheduled transaction according to aspects of the present disclosure.

FIG. 8 illustrates an overview of an example user interface for requesting user information associated with a transaction recipient.

FIG. 9 illustrates an overview of an example user interface for providing confirmation of a scheduled transaction.

FIG. 10 illustrates an overview of an example user interface for providing an indication that a transaction recipient is no longer linked with a user account.

FIG. 11 illustrates an overview of an example user interface for providing an indication of a successful transaction.

FIG. 12 illustrates an overview of an example user interface for providing an indication that a fallback transaction route will be used to complete a transaction.

FIG. 13 illustrates an example of a suitable operating environment in which one or more aspects of the present application may be implemented.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In examples, a user may transfer one or more resources (e.g., data, items, money or currency, etc.) to a transaction recipient. A transaction platform may facilitate transactions between users and recipients using any of a variety of transaction routes. Each transaction route may have a set of route characteristics, including, but not limited to, a route cost, a processing duration, a set of verification requirements, and an associated connection or proxy. As a result of such route characteristics and, in some examples, characteristics associated with the transaction (e.g., a quantity and/or value of associated resources, a transaction date, attributes of the user, or attributes of the recipient), the transaction route used by the transaction platform may affect transaction processing.

For example, if the transaction platform routes a transaction via one transaction route as compared to another transaction route, the likelihood of success for the transaction, the expediency with which the transaction is completed, or the cost associated with completing the transaction may change, among other examples. Accordingly, selecting a transaction route from a set of available transaction routes may impact transaction timeliness or may affect the user experience offered by the transaction platform. Additionally, even if the transaction platform identifies a transaction route that is likely to complete the transaction on or before an expected date, within an expected time period, or offer an expected user experience, the route (which may be referred to herein as a preferred transaction route) may not behave as expected, such that the transaction may instead be completed via a fallback transaction route. Thus, routing transactions using various transaction routes while managing user expectations and maintaining a user experience associated with a transaction platform may be difficult, for example given such variability and the potential for transaction failures.

Accordingly, aspects of the present application relate to transaction health monitoring and fault-tolerant and/or attribute-based routing. In examples, a transaction platform monitors transaction success rates for transaction routes. For example, transactions associated with a given transaction route that have the same or similar attributes may be grouped together, such that it may be determined whether transactions having certain attributes are more likely to succeed via the transaction route (e.g., as compared to other transactions having similar attributes via one or more other transaction routes and/or based on a maintenance indication or in view of a maintenance schedule). Thus, the transaction platform may determine the “health” of a given transaction route.

As a result of determining transaction route health for available transaction routes, transaction rules may be generated or updated and used to route transactions accordingly. For example, based on determining that an attribute indicates that a transaction is more likely to succeed via a given route, a transaction rule may be created that causes transactions having the attribute to be routed via the determined route. In some instances, a transaction rule may be associated with multiple attributes or, as another example, transaction rules may be hierarchical, such that a first transaction rule may supersede a second transaction rule. In other instances, a transaction rule may cause the transaction platform to add, remove, or modify one or more attributes associated with a transaction, such that the transaction platform may adapt a set of attributes associated with a transaction according to a transaction rule to increase the likelihood of success for a given transaction route. Thus, in addition to transaction route health, such a set of transaction rules may enable the transaction platform to process a transaction according to a likelihood of success for the transaction.

In instances where a transaction route exhibits a success rate or health below a predetermined threshold, the transaction processor may identify a subset of transactions (e.g., randomly or according to one or more criteria) and adapt each transaction to exhibit various attributes. Thus, the transaction processor may generate additional information (e.g., based on such adapted transactions in addition to un-adapted transactions) usable to determine whether a different set of attributes would improve the success rate of the transaction route. It will be appreciated that such techniques need not be limited to instances where the success rate is below a predetermined threshold. For example, such techniques may alternatively or additionally be applied after a predetermined time period has elapsed, in response to changes associated with the transaction route, and/or after a predetermined number of transactions have been routed via the transaction route. As another example, similar techniques may be used to divert a subset of transactions for a transaction route having a success rate and/or health above a predetermined threshold to one or more other transaction routes that are new, that have outdated information, or that have insufficient information, among other examples, thereby generating additional information for the other transaction routes.

In some instances, certain transaction rules may affect different aspects of the transaction platform. For example, a transaction rule may be associated with technical aspects of the transaction platform (e.g., routing a transaction via one proxy or network connection as compared to another proxy) or may be associated with the operational aspects of the transaction platform (e.g., routing a transaction to incur to one transaction fee as compared to another transaction fee). In such instances, some transaction rules may be automatically implemented by the transaction platform, while others may be provided for manual review by a user associated with the transaction platform.

For example, technical transaction rules may be automatically implemented, while operational transaction rules may be provided for manual review. In some instances, only a subset of the operational transaction rules may be provided for manual review, such as those that exceed a predetermined threshold (e.g., a transaction cost change above a predetermined percentage or having an estimated variance outside of a predetermined range). In other instances, machine learning techniques may be applied to determine whether to provide a transaction rule for manual review or to automatically implement the transaction rule. For example, a machine learning model may be trained (e.g., according to supervised and/or unsupervised techniques) based on historical transaction rules that were manually approved or rejected, such that the machine learning model may categorize transaction rule changes accordingly.

A transaction platform may update or otherwise change transaction rules according to any of a variety of schedules or in response to any of a variety of events. For example, transaction rules may be updated dynamically according to identified changes in transaction route health. As another example, transaction rules may be updated periodically (e.g., hourly, nightly, weekly, or monthly). It will be appreciated that transaction rules associated with one transaction route need not be updated at the same time as transaction rules associated with another transaction route.

Similarly, while examples herein are described with respect to changing transaction rules to improve the success rate (e.g., of a transaction route and/or transactions routed therewith), it will be appreciated that any of a variety of other factors may be evaluated in addition to or as an alternative to success rate. For example, transaction rules may be generated based on associated transaction costs, likelihood of rate-limiting and/or automated processing detection, variability of a transaction route cost, likelihood of falling back to or otherwise utilizing a different transaction route, and/or processing duration. In some instances, a set of specialized transaction rules may be generated for a specific user, recipient, and/or route, such that the set of specialized transaction rules is applied to transactions associated therewith, while a general set of transaction rules is applied to other transactions. As a result of processing a transaction according to a set of transaction rules, it will be appreciated a transaction route used for a set of similar transactions may vary according to changes in one or more factors, such as time of day, whether a transaction route is undergoing maintenance, and/or whether rate-limiting is likely to be encountered (e.g., even in view of an increased cost, increased transaction time, and/or decreased reliability), among other examples.

A transaction platform may process any of a variety of transaction types, including scheduled transactions, recurring transactions, testing and/or validation transactions, and on-demand transactions. For example, a user may schedule a transaction with a transaction recipient at a time in the future. A recurring transaction may be a fixed recurring transaction (e.g., for the same set and/or amount of resources) or may be dynamic (e.g., based on information obtained from a user and/or transaction recipient), among other examples. A recurring transaction may effectively cause the generation of one or more scheduled transactions (e.g., according to a predetermined schedule or in response to an indication from a transaction recipient). A recurring transaction may be cancelled by a user or by a transaction recipient, among other examples. As another example, a user may request that a transaction be performed on-demand, such that the transaction platform initiates the transaction substantially contemporaneously with the request (e.g., on the same day or in an upcoming batch of transactions with the recipient). In some instances, a transaction with a recipient may be recurring, as may be the case when the user provides resources on a monthly basis to a recipient such as a monthly service provider. In such an example, a success rate associated with past transactions and/or the user may be evaluated as an alternative to or at a higher weighting than another success rate (e.g., associated with a transaction recipient) for a given transaction route. It will be appreciated that any of a variety of time periods may be used for recurring transactions.

A transaction platform may enable a user to link a user account with a transaction recipient, such that the user need not repeatedly enter user information associated with transacting with the recipient. For example, the user account may store information associated with a resource manager from which a resource is transferred when transferring the resource to the transaction recipient. As a further example, the user account may store recipient information associated with the recipient, including, but not limited to, an authentication token, a session identifier, a username and password, a user account number for the recipient, a preferred browser, a cellphone carrier, an internet service provider, and/or a billing address.

Accordingly, such information associated with a user account may enable the transaction platform to complete on-demand, scheduled, and/or recurring transactions on behalf of a user. For example, as a result of linking a recipient with a user account, the transaction platform may complete transactions with the recipient in advance of a transaction due date. Thus, the recipient may periodically provide an indication of a new transaction, and the transaction platform may complete the transaction on behalf of the user using the information associated with the user account.

In some instances, the transaction platform maintains additional or alternative health information. For example, the transaction platform may evaluate a linking health of a given recipient to determine whether the recipient is likely to be available to be linked to a user account for a user of the transaction platform. In some instances, the evaluation of linking health may be with respect to a specific user, with respect to a set of users, and/or with respect to a given recipient, such that it may be determined whether the user is able to resolve a linking issue (e.g., where a user may re-enter authentication information) or whether the recipient is experiencing a more widespread linking issue (e.g., where transaction recipient is experiencing an outage, where maintenance is ongoing, where there is an unexpected surge in traffic, or where there is a new local event).

As a further example, the transaction platform may evaluate a synchronization health of a given recipient to determine whether the recipient is available to provide new transaction indications or from which to obtain information associated with a user, among other examples. In some instances, the evaluation of synchronization health may be with respect to a specific user or with respect to a set of users, such that it may be determined whether the user is able to resolve a synchronization issue or whether the recipient is experiencing a more widespread synchronization issue. Route health, linking health, and/or synchronization health may be used to route transactions between a user and a recipient according to the techniques described herein so as to improve the likelihood that a transaction is successful, for example by a given deadline.

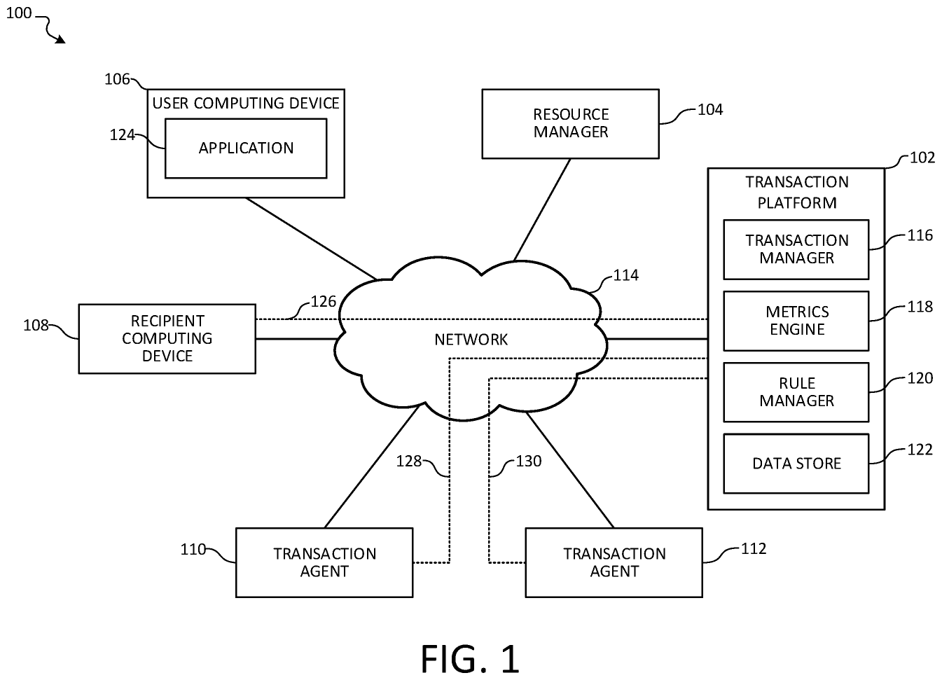

FIG. 1 illustrates an overview of an example system 100 for transaction health monitoring and fault-tolerant routing. As illustrated, system 100 comprises transaction platform 102, resource manager 104, user computing device 106, recipient computing device 108, transaction agent 110, transaction agent 112, and network 114. In examples, transaction platform 102, resource manager 104, user computing device 106, recipient computing device 108, transaction agent 110, and transaction agent 112 communicate via network 114. For example, network 114 may comprise a local area network, a wireless network, or the Internet, or any combination thereof, among other examples.

As illustrated, transaction platform 102 comprises transaction manager 116, metrics engine 118, rule manager 120, and data store 122. In examples, transaction manager 116 processes transactions according to aspects described herein. For example, a user of user computing device 106 may use application 124 to initiate a transaction of a resource to a recipient associated with recipient computing device 108. Application 124 may be any of a variety of applications, including, but not limited to, a native application, a web-based application, or any combination thereof.

In some instances, the resource may be managed by resource manager 104. For example, resource manager 104 may manage any of a variety of resources for a user (e.g., of user computing device 106), including, but not limited to, data, items of monetary value, and/or currency. Thus, it will be appreciated that resource manager 104 may be associated with any of a variety of entities, including, but not limited to, a cloud services provider (e.g., which may manage data for a user) or a bank (e.g., which may manage assets of the user). Accordingly, resource manager 104 may communicate with transaction platform 102 (e.g., via an application programming interface (API) or website) to facilitate the transaction of an associated resource. In other examples, a resource need not be managed by resource manager 104.

Transaction platform 102 may receive an indication of the transaction (e.g., from resource manager 104 or user computing device 106), where it is processed according to a set of transaction rules stored in data store 122. In examples, transaction rules of data store 122 may be generated or otherwise maintained by rule manager 120. For instance, route health information and/or additional information associated with transaction manager 116 is generated by metrics engine 118.

For example, metrics engine 118 may process transaction completion information to generate transaction route health. Example transaction completion information includes, but is not limited to, whether the transaction succeeded, a cost incurred by processing the transaction, which transaction route was used for the transaction, transaction attributes (e.g., associated resources, transaction start date, or transaction completion date), user attributes (e.g., user authentication information, client type such as private or commercial, geographic location of the user, and resource manager information), and recipient attributes (e.g., whether the recipient is private or commercial, geographic location of the recipient, and/or resource manager information). Rule manager 120 may process such information to maintain the set of transaction rules used by transaction manager 116. As discussed above, rule manager 120 may automatically implement generated rules and/or update existing rules. As another example, rule manager 120 may request and subsequently receive user input either approving, rejecting, or modifying a proposed transaction rule change.

As illustrated, system 100 comprises transaction route 126, transaction route 128, and transaction route 130. For example, transaction route 126 may enable transaction platform 102 to complete a transaction directly with recipient computing device 108 (e.g., via an API, a website, or an electronic communication), while transaction routes 128 and 130 are facilitated via transaction agents 110 and 112, respectively.

For example, transaction agent 110 or 112 may receive, store, transmit, or otherwise manage resources associated with such transactions. As another example, transaction agent 110 or 112 may manage a resource provided by resource manager 104, such that the resource may ultimately be provided to recipient computing device 108 via transaction platform 102. Example transaction agents include, but are not limited to, transaction processors and banks. For example, transaction agent 110 may be an issuing bank or an acquiring bank associated with a credit card processing entity, while transaction agent 112 may be a bank via which transactions are performed using an automated clearing house (ACH) network. Transaction agent 110 and/or 112 may each be comprised of one or more computing devices, including, but not limited to, a desktop computer, a server computer, and/or a point-of-sales system, among other examples. While examples are described herein with respect to a transaction platform and an associated transaction agent, a transaction platform may implement such functionality in other examples, such that a separate transaction agent need not be used.

Transaction routes 126, 128, and 130 are each illustrated as using network 114. However, it will be appreciated that each transaction route need not use the same network connection or communication technology, among other examples. As an example, transaction route 126 may utilize a first connection to network 114 (e.g., a fiber or cable Internet connection), while transaction route 128 may comprise a second connection to network 114 (e.g., a cellular or satellite Internet connection). As another example, transaction route 130 may utilize electronic communication (e.g., messages via a message bus, instant messages, or email messages). As a further example, a transaction route may utilize telephone communication, via which communication is made with an automated system of a transaction agent or, in other examples, a user may communicate with the automated system or an automated system (e.g., of transaction platform 102) may communicate with a user associated with transaction agent 112. Thus, it will be appreciated that a transaction route may utilize any of a variety of communication technologies.

Thus, transaction manager 116 may route the transaction via transaction route 126, 128, or 130 based on the set of transaction rules. The selected transaction route may be referred to as a preferred transaction route. For example, the preferred transaction route may be a route identified as a result of evaluating the set of transaction rules or, as another example, transaction routes may be scored according to the transaction rules, such that the highest-ranking transaction route may be determined to be the preferred transaction route. Thus, transaction manager 116 may evaluate any of a variety of attributes associated with the transaction according to the set of transaction rules, as described above. As another example, transaction manager 116 may add, remove, or alter attributes of the transaction according to the set of transaction rules, for example to improve the likelihood of success of the transaction for an identified transaction route.

In some instances, transaction manager 116 may determine that a preferred transaction route has not behaved as expected. For example, the transaction route may be operating at a decreased speed or decreased volume as compared to historical or projected metrics. As another example, a success rate associated with the transaction route may be below a predetermined threshold. Such a determination may be made based on a behavior associated with the transaction discussed above or may be determined based on metrics associated with multiple transactions. In some instances, such a determination may be made prior to transmitting a transaction via an identified transaction route, for example based on a current or projected health for the transaction route. In other instances, it may be determined that the transaction failed via the preferred transaction route. As a result, transaction manager 116 may evaluate the set of transaction rules to identify a fallback transaction route accordingly. It will be appreciated that any number of fallback transaction routes may be identified (e.g., in addition to the first fallback transaction route described above).

In examples, a user account of transaction platform 102 may be linked with a transaction recipient, such as a transaction recipient associated with recipient computing device 108. For example, a user may use application 124 to provide recipient information with which transaction platform 102 may initialize a link to the transaction recipient. Accordingly, transaction platform 102 may receive, access, or otherwise obtain transaction information from recipient computing device 108 accordingly. Thus, a user may be able to schedule recurring transactions with the transaction recipient according to transaction information from the transaction recipient as a result of such a link. In some instances, a transaction recipient may be temporarily unavailable for linking or a user may need to reestablish a link with the transaction recipient, additional aspects of which are described below in greater detail.

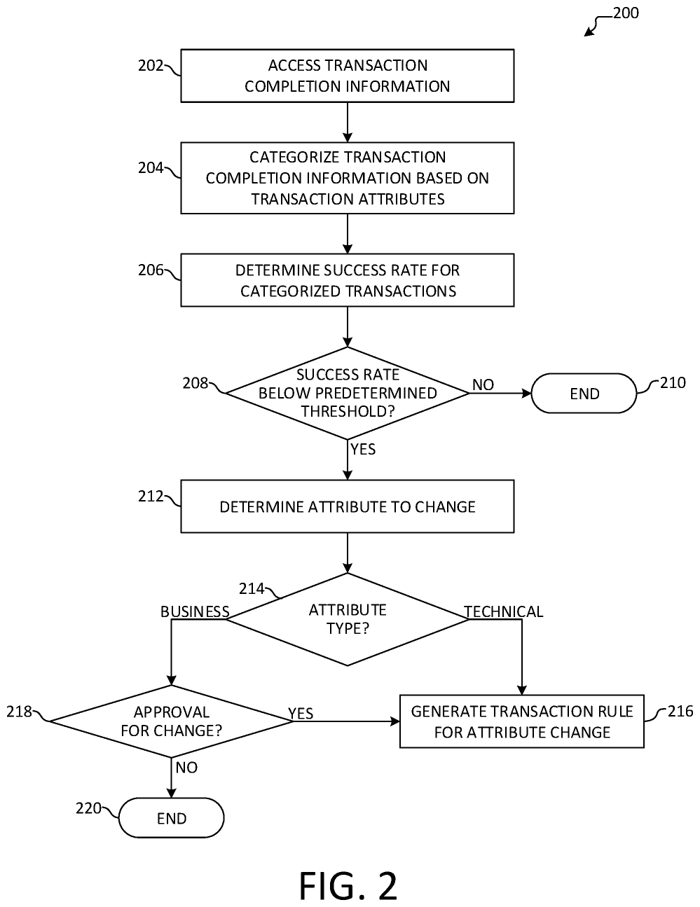

FIG. 2 illustrates an overview of an example method 200 for evaluating transaction health and adapting transaction rules and associated transaction routes according to aspects of the present disclosure. In examples, aspects of method 200 may be performed by a transaction platform, such as transaction platform 102 in FIG. 1. Method 200 may be performed periodically and/or in response to any of a variety of events, such as when it is determined that the success rate of a transaction route falls below a predetermined threshold or in response to a manual indication to perform aspects of method 200.

Method 200 begins at operation 202, where transaction completion information is accessed. In examples, the transaction completion information is accessed from a data store, such as data store 122 discussed above with respect to FIG. 1. The transaction completion information may be accessed based on an association with one or more transaction routes, transaction recipients, or a predetermined time period, among any of a variety of alternative or additional criteria.

Flow progresses to operation 204, where the transaction completion information is categorized according to transaction attributes associated therewith. For example, transaction completion information may be accessed according to a predetermined time period at operation 202, such that it may be categorized based on one or more associated transaction routes. As another example, transaction completion information may be categorized according to associated recipients or depending on resources associated therewith (e.g., above a predetermined threshold, within a predetermined range, or according to a set of predetermined ranges), among other examples. For instance, a machine learning model may be used to categorize the transaction completion information into any of a variety of categories.

At operation 206, a success rate is determined for the categorized transactions. For example, a success rate may be determined for each category that was generated at operation 204. Returning to the examples discussed above, success rates may be determined for one or more transaction routes, recipients, and/or resource value ranges, among other examples. As an example, a success rate may be determined according to whether a transaction was ultimately successful, whether a transaction was completed within a predetermined amount of time, or whether a transaction was reverted or returned after completion, among other examples.

Flow progresses to determination 208, where it is determined whether a success rate determined at operation 206 is below a predetermined threshold. For example, the predetermined threshold may be based on a historical success rate or based on a user-configurable success rate. As an example, a user of a transaction platform may specify an acceptable success rate that is different from other users of the transaction platform. If it is determined that the success rate is not below the predetermined threshold, flow branches “NO” and terminates at operation 210.

However, if it is instead determined that a success rate is below the predetermined threshold, flow instead branches “YES” to operation 212, where an attribute to change is determined. In examples, the determination comprises comparing attributes associated with one category to attributes associated with another category to identify differences. For example, it may be determined that one category of transactions having the attribute exhibited a higher success rate than another category of transactions that does not have the attribute. Similarly, different values of an attribute may be evaluated. In some examples, the determination comprises evaluating an estimated improvement associated with changing the attribute, such that an attribute may be identified that has a greater expected impact than another attribute.

At determination 214, it is determined whether the attribute determined at operation 212 is a business attribute or a technical attribute, such that flow branches accordingly. While method 200 is described in a context where a single attribute is changed, it will be appreciated that multiple business attributes, technical attributes, or any combination thereof may be identified and processed according to aspects described herein.

Accordingly, if the attribute is a technical attribute, flow branches to operation 216, where a transaction rule is generated accordingly based on the determined attribute. For example, the generated transaction rule may specify that an attribute of a transaction processed according to the transaction should be changed (e.g., added, removed, or modified). As another example, the generated transaction rule may be associated the determined attribute with a transaction route, such that the transaction rule specifies that transactions exhibiting the attribute should be routed via the transaction route. It will be appreciated that a transaction rule need not yield a discrete determination (e.g., as to a specific transaction route), but may instead generate a score for a transaction route. Thus, the generated transaction rule may score the transaction route associated with the determined attribute higher than other transaction routes. It will be appreciated that operation 216 may comprise generating a new transaction rule, removing a transaction rule, or updating a transaction rule, among other examples. Flow terminates at operation 216.

However, if the attribute is a business attribute type, flow instead branches to determination 218, where it is determined whether there is approval for the change. In examples, determination 218 comprises generating an alert and receiving an associated user input either accepting, rejecting, or changing the proposed change. In other examples, the determination may be made based at least in part on a machine learning model. Thus, it will be appreciated that determination 218 may comprise any of a variety of evaluations. If it is determined there is not approval for the change, flow branches “NO” and terminates at operation 220. However, if it is determined that there is approval for the change, flow instead branches “YES” to operation 216, where a transaction rule is generated accordingly, as described above.

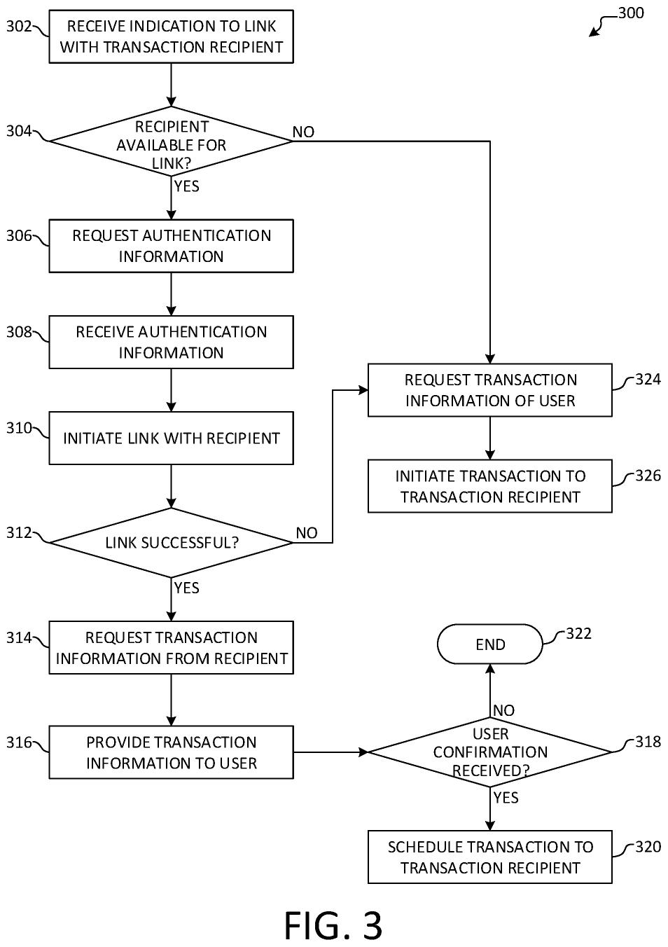

FIG. 3 illustrates an overview of an example method 300 for linking with a transaction recipient to facilitate one or more transactions between a user and the transaction recipient. In examples, aspects of method 300 are performed by a transaction platform, such as transaction platform 102 discussed above with respect to FIG. 1.

Method 300 begins at operation 302, where an indication to link with a transaction recipient is received. For example, the indication may be received from a user computing device, such as user computing device 106 discussed above with respect to FIG. 1. The indication may be received as a result of a user initiating a transaction with the recipient, whereby a link created as a result of aspects of method 300 may be used to schedule the transaction accordingly. In other examples, the indication may be received as a result of a user selecting the transaction recipient from a list of transaction recipients associated with a transaction platform, for example transaction recipients for which linking is available. In examples, one or more recipient defaults may be used (e.g., as may be the case when a user has not provided information or information is unavailable).

At determination 304, it is determined whether the recipient is available for linking. For example, the determination may be based on historical information associated with the recipient (e.g., transaction completion information associated with the recipient). As another example, the determination may be made based on evaluating the availability of an API associated with the recipient, where it may be determined whether a computing device associated with the recipient is accessible via a network (e.g., recipient computing device 108 via network 114 in FIG. 1).

At operation 306, a request for user authentication information is generated. As an example, an indication may be provided to a user computing device of the user to request authentication information of the user. In response, the user computing device may present a user interface via which user input may be received comprising the authentication information. Any of a variety of alternative or additional information may be used in other examples.

Flow progresses to operation 308, where user authentication information is received. For example, a username and password associated with a recipient may be received at operation 308. As another example, an authorization token may be received, as may be the case when the user computing device receives user input associated with a single sign-on (SSO) or OAuth authentication scheme. Thus, it will be appreciated that any of a variety of authentication information may be used to initiate a link with a recipient according to aspects described herein.

At operation 310, a link is generated with the recipient. For example, an API of a recipient computing device may be used to establish a link with the recipient, such that the resulting link may be used for subsequent communication with the recipient. In some examples, a session token or other information may be provided, which may be used in a subsequent communication with a recipient computing device accordingly. In other instances, an indication may be received that a link was not established, as may be the case when the user authentication information received at operation 308 is incorrect or if a recipient computing device is experiencing an issue, among other examples.

Accordingly, at determination 312, it is determined whether the link was successful. For example, the determination may comprise evaluating a response from a recipient computing device that was received at operation 310 or, as another example, the determination may comprise making another call via an API of the recipient to determine whether a link was successfully established.

If it is determined at determination 312 that the link was not successfully established, flow branches “NO” to operation 324, where transaction information associated with the user is requested. For example, an indication may be provided to the user computing device that causes the user computing device to request user input (e.g., such that the user may enter the transaction information or select saved transaction information). In other examples, the transaction information may be obtained from a user profile associated with the user, as may be stored by a transaction platform such as transaction platform 102 in FIG. 1. Example transaction information includes, but is not limited to, one or more resources for transfer to the recipient and/or information associated with a resource manager and/or transaction platform (e.g., a user account, user alias, or user identifier), among other examples.

Flow progresses to operation 326, where a transaction to the transaction recipient is initiated according to the transaction information that was requested from the user. For example, the transaction may be scheduled for a later date or may be processed according to a set of transaction rules and a resulting transaction route, as described above. Thus, aspects of method 300 enable a transaction to be performed even in instances where a recipient is unavailable for linking. Method 300 ends at operation 326.

If, however, it is instead determined that the link was successfully established, flow instead branches “YES” to operation 314, where transaction information is requested from the recipient. For example, a request may be provided to a recipient computing device using an API associated with the recipient. In some examples, the request comprises a session token or other identifier that was received above in operation 310. Thus, as compared to operations 324 and 326 discussed above, operation 314 enables at least a part of the transaction information to be requested from the transaction recipient rather than the user.

At operation 316, an indication of the requested transaction information is provided for display to the user. For example, at least a part of the transaction information received from a recipient computing device may be provided for display by a user computing device, thereby enabling a user to verify that the transaction information is correct. In some instances, operation 316 further comprises receiving user input associated with the transaction information, such as a date on which the transaction should occur and/or an account or other identifier that should be used for the transaction. As another example, user input may be received to approve the transaction and/or to schedule transactions with the transaction recipient on a recurring basis, such that transaction information may be requested from the recipient via the link established at operation 310 and transactions may be automatically initiated accordingly.

Flow progresses to determination 318, where it is determined whether user confirmation is received to perform the transaction. As discussed above, operation 316 may comprise obtaining user confirmation of the transaction or, as another example, the absence of a user rejecting the transaction (e.g., within a predetermined time period) may be determined to constitute user confirmation of the transaction. In some examples, an indication of a change may be received in response to the indication that was provided at operation 316 (e.g., changing a recipient, one or more resources and/or associated amounts, etc.), such that a transaction scheduled at operation 320 is scheduled according to such a received change.

Accordingly, if it is determined that user confirmation is received, flow branches “YES” to operation 320, where the transaction to the transaction recipient is scheduled. For example, the transaction may be scheduled for a later date or may be processed according to a set of transaction rules and a resulting transaction route, as described above. In examples where transactions to the transaction recipient are to occur on a recurring basis, scheduling the transaction to the transaction recipient may comprise scheduling a recurring transaction with the transaction platform, where transaction information is retrieved and subsequently used to complete a transaction on a recurring basis. Flow terminates at operation 320. If, however, it is instead determined that user confirmation is not received, flow instead branches “NO” and ends at operation 322.

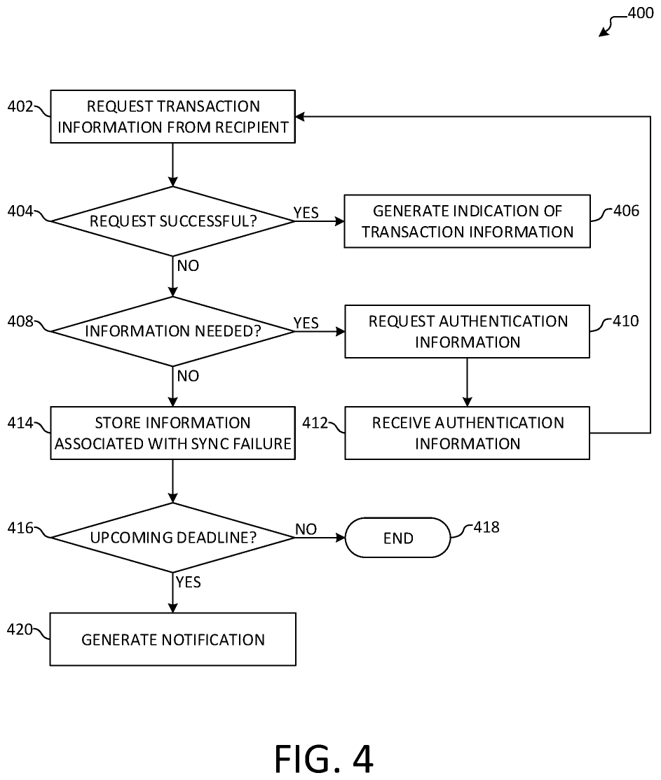

FIG. 4 illustrates an overview of an example method 400 for synchronizing data from a transaction recipient. In examples, aspects of method 400 are performed by a transaction platform, such as transaction platform 102 discussed above with respect to FIG. 1. In examples, aspects of method 400 are performed periodically to synchronize with the transaction recipient as new data is available. In some instances, aspects of method 400 are performed independent of scheduling a transaction and/or when a transaction is not imminent. For example, aspects similar to method 400 may be used to obtain information associated with a user, a recipient, and/or a scheduled transaction. Examples include, but are not limited to, an itemized set of transactions associated with a user and/or upcoming transaction, and remittance information associated with a recipient. In examples, such remittance information may be cached, such that it may be used even in instances where a recipient is temporarily unavailable.

Method 400 begins at operation 402, where transaction information is requested from a transaction recipient. For example, a link with a transaction recipient (e.g., as may be formed as a result of performing aspects of method 300 discussed above with respect to FIG. 3) may be used to request transaction information from a computing device associated with the transaction recipient. For example, the transaction information may be requested using an API or a website of the transaction recipient, among other examples.

At determination 404, it is determined whether the request for information was successful. For example, a response may be received as a result of the request at operation 402 comprising transaction information and/or comprising an indication as to the status of the request. As another example, the request generated at operation 402 may timeout. Thus, if, at determination 404, it is determined that the request was successful, flow branches “YES” to operation 406, where an indication of transaction information associated with the transaction recipient is generated. For example, the indication may be provided to a computing device of a user, such that the user may receive an indication of an upcoming transaction or, as another example, the user may approve and/or schedule a transaction associated therewith, among other examples. For example, an indication of a new bill may be provided at operation 406. Flow terminates at operation 406.

If, however, it is determined that the request was unsuccessful at determination 404, flow instead branches “NO” to determination 408, where it is determined whether additional information is needed to request the transaction information from the transaction recipient. For example, determination 408 may comprise evaluating a response that was received at operation 402, similar to operation 404 discussed above. For example, a link with the transaction recipient may have expired or may be otherwise broken, such that a new link may be established similar to aspects described above with respect to method 300 in FIG. 3. Accordingly, if it is determined that additional information is needed, flow branches “YES’ to operation 410, where user authentication information is received. As discussed above, any of a variety of authentication information may be requested, such that it is received at operation 412 and used to re-request the transaction information at operation 402. Thus, an arrow is illustrated from operation 412 to operation 402 to indicate that, in some examples, the request may be retried based on information received from a user.

If, however, it is determined that information is not needed at operation 408 (e.g., a link with the transaction recipient is still intact), flow instead branches “NO” to operation 414, where information associated with the synchronization failure is stored. For example, the information may be stored in a data store, such as data store 122 in FIG. 1. Such stored information may be processed by a metrics engine (e.g., metrics engine 118 in FIG. 1) to generate a health associated with the transaction recipient. For example, transaction recipient health may be used to determine whether the recipient is available for linking, as discussed above with respect to determination 304 in FIG. 3.

Flow progresses to operation 416, where it is determined whether there is an upcoming transaction deadline. For example, the determination may comprise evaluating previous transaction information that was obtained from the transaction recipient, previous transactions with the transaction recipient, and/or one or more previous or upcoming scheduled transactions, among other examples. If there is not an upcoming deadline, flow branches “NO” and terminates at operation 418.

If, however, it is determined that there is an upcoming deadline, flow instead branches “YES” to operation 420, where a notification is generated. For example, the notification may indicate that it was not possible to request information from the transaction recipient and/or that a transaction to the transaction recipient may be late, among other examples. In such instances, a user device may enable a user to provide additional information and/or schedule a transaction to remedy or otherwise mitigate the failed request for transaction information. Flow terminates at operation 420.

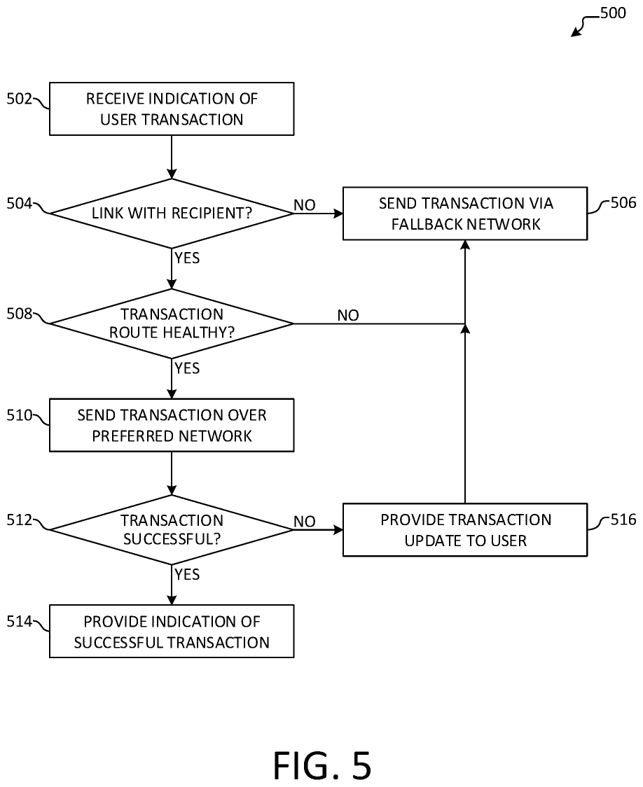

FIG. 5 illustrates an overview of an example method 500 for processing a transaction with a transaction recipient based on a user indication. In examples, aspects of method 500 are performed by a transaction platform, such as transaction platform 102 in FIG. 1.

Method 500 begins at operation 502, where an indication of a user transaction is received. For example, the indication may be received from an application of a user computing device, such as application 124 of user computing device 106 in FIG. 1. As another example, the indication may be associated with a scheduled transaction, as may have been scheduled as a result of performing aspects of method 300 discussed above with respect to FIG. 3. As an example, the indication may comprise an indication of one or more resources and a transaction recipient, among other examples.

Flow progresses to determination 504, where it is determined whether there is a link with the transaction recipient. For example, the link with the transaction recipient may have been formed as a result of performing aspects of method 400 discussed above with respect to FIG. 4. Determination 504 may comprise evaluating a transaction recipient health for the transaction recipient or, as another example, the determination may comprise making a call via an API of the recipient to determine whether a link is currently available.

If it is determined that there is not a link with the transaction recipient (e.g., a link was never established, the link is determined to be unhealthy or is currently unavailable, or a session associated with the link has expired), flow branches “NO” to operation 506, where the transaction is performed using a fallback transaction route. In examples, the fallback transaction route may be determined using a set of transaction rules according to aspects described herein. As noted above, the fallback transaction route may vary according to one or more factors as a result of evaluating the set of transaction rules. In other examples, the fallback transaction route may be a route specified by the user and/or the transaction platform. Thus, it will be appreciated that any of a variety of techniques may be used to determine a fallback transaction route via which to send the transaction. It will be appreciated that aspects of method 500 may be performed multiple times, as may be the case when multiple fallback routes are used. Flow terminates at operation 506.

If, however, it is determined that there is a link with the recipient, flow instead branches “YES” to determination 508, where it is determined whether a transaction route is healthy. For example, a transaction route may be determined according to a set of transaction rules, where a health for the determined transaction route may be generated according to transaction completion information (e.g., as may be processed by a metrics engine such as metrics engine 118 in FIG. 1). Accordingly, if it is determined that the transaction route is not healthy, flow branches “NO” to operation 506 where the transaction is sent via a fallback route and terminates, as described above. In some instances, operation 506 comprises providing an indication for display comprising an estimated timeframe for transaction completion according to the fallback transaction route. For example, the estimated timeframe may be for an electronic biller network (EBN) transaction route or a check transaction route.

However, if it is determined at determination 508 that the transaction route is healthy, flow instead branches “YES” to operation 510, where the transaction is sent via the transaction route accordingly. In some instances, operation 510 comprises providing an indication for display to a user that it is possible to perform the transaction substantially contemporaneously with the indication received at operation 502 or by a deadline. Thus, as compared to operation 506, operation 510 may cause a transaction to be performed more quickly.

At determination 512, it is determined whether the transaction was successful. For example, an indication associated with the transaction route may be received (e.g., from a transaction agent associated therewith or from the transaction recipient). As another example, an indication may be received only in instances where a transaction fails, such that determination 512 may comprise determining whether an indication is received within a predetermined amount of time.

Accordingly, if it is determined that the transaction was not successful at determination 512, flow branches “NO” to operation 516, where a transaction update is provided to the user. For example, the transaction update may comprise an indication that sending the transaction at operation 510 was not successful (e.g., that a substantially contemporaneous transaction to the transaction recipient was not possible) and that the transaction will instead be sent via a fallback transaction route. In some instances, the transaction update may comprise an indication of an updated estimated completion date. Flow progresses to operation 506, where the transaction is sent via the fallback route and terminates, as discussed above.

If, however, it is determined that the transaction was successful, flow instead branches “YES” to operation 514, where an indication of a successful transaction is provided. For example, the indication may comprise confirmation information (e.g., a confirmation number, a date when the transaction was completed, and/or information associated with the transaction route). The indication may be provided using any of a variety of techniques, such as to an application of a user computing device or as an electronic communication, among other examples. Method 500 terminates at operation 514.

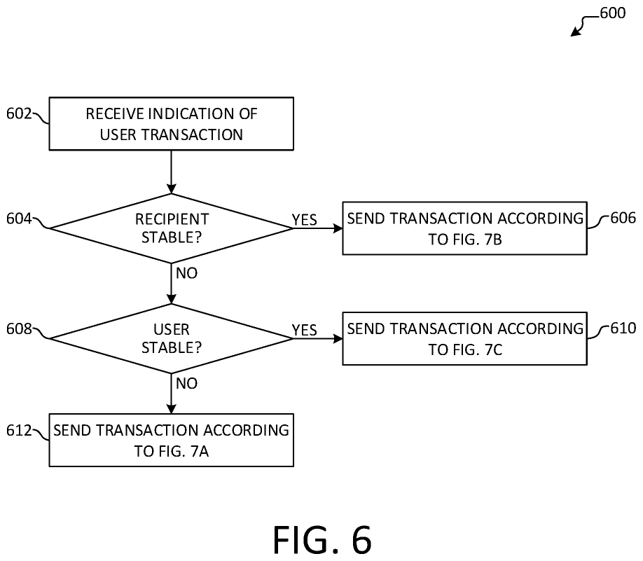

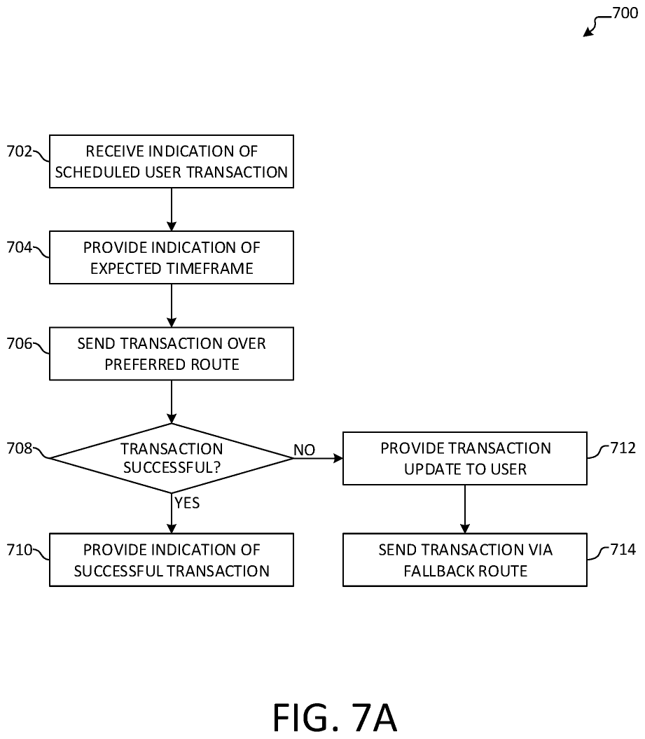

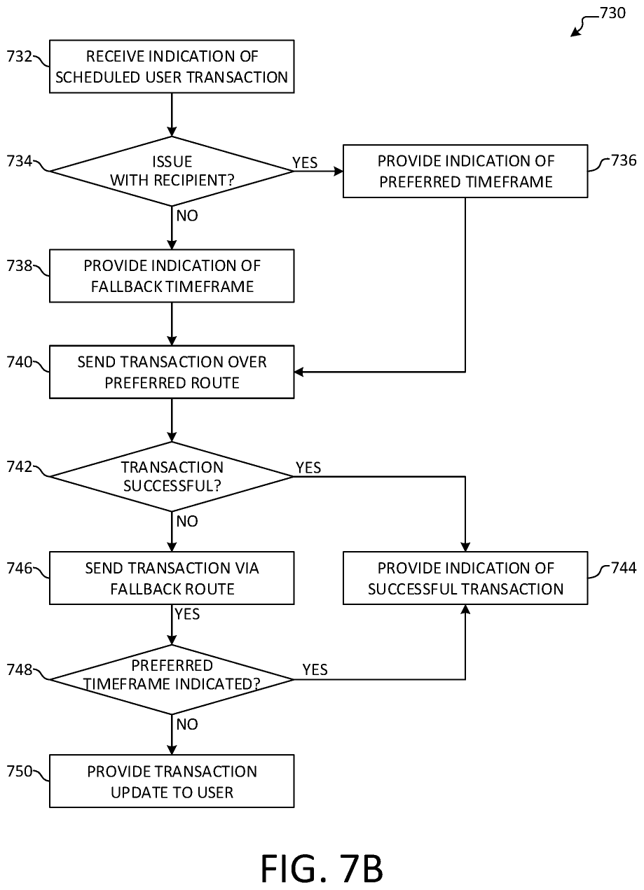

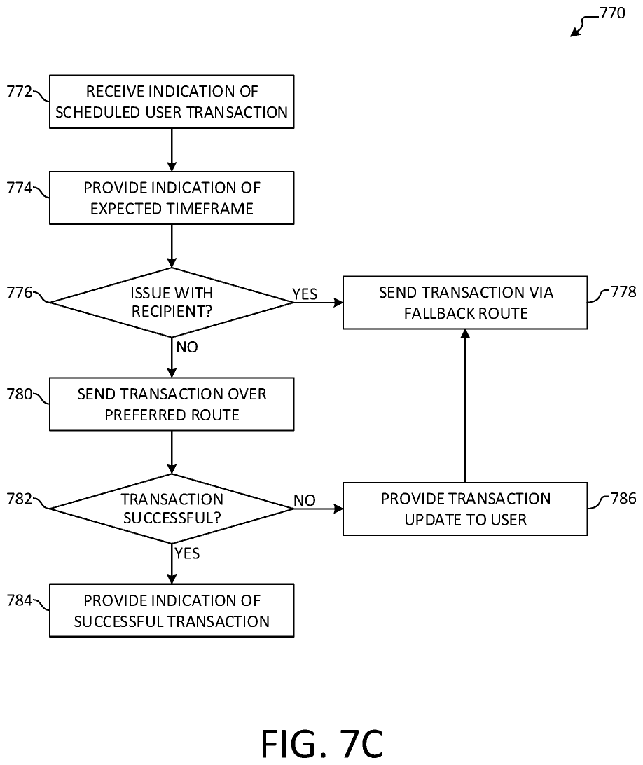

FIG. 6 illustrates an overview of an example method 600 for processing a transaction according to aspects described by FIG. 7A, 7B, or 7C. In examples, aspects of method 600 are performed by a transaction platform, such as transaction platform 102 in discussed above with respect to FIG. 1. For example, the transaction platform may perform method 600 to determine which of methods 700, 730, or 770 of FIGS. 7A, 7B, and 7C, respectively, to perform.

Method 600 begins at operation 602, where an indication of a scheduled user transaction is received. For example, the indication may be received from an application of a user computing device, such as application 124 of user computing device 106 in FIG. 1. As another example, the indication result from performing aspects of method 300 discussed above with respect to FIG. 3. As an example, the indication may comprise an indication of one or more resources and a transaction recipient, among other examples. The indication may comprise an indication as to a date that the transaction should be sent or by which the transaction must be completed, among other examples.

Accordingly, at determination 604, it is determined whether a transaction recipient for the transaction is stable. As an example, determination 604 may comprise evaluating one or more metrics associated with the recipient as compared to one or more predetermined thresholds and/or based on a set of rules, among other examples.

If it is determined that the recipient is stable, flow branches “YES” to operation 606, where the transaction is processed according to aspects discussed below with respect to method 730 of FIG. 7B. As a result of processing the transaction according to such aspects, an expected timeframe indication may be provided according to a set of metrics associated with a recipient (e.g., as a result of a forecast associated with recipient stability), while a preferred transaction route may ultimately be used even in instances where the estimated timeframe is associated with a fallback transaction route. In such an example, resources may be transacted in advance of an expected timeframe (e.g., via the fallback transaction route; in instances where the preferred transaction route is unavailable or is predicted to be unsuccessful), such that the stability determination at determination 608 may effectively determine whether one or more resources are likely to be available should a fallback transaction route be used to process the transaction early.

By contrast, if it is instead determined that the transaction recipient is not stable, flow branches “NO” to determination 608, where it is determined whether the user associated with the transaction is stable. Similar to determination 604, determination 608 may comprise evaluating one or more metrics (e.g., a transaction history of the user, a number of transactions, a quantity and/or type of available resources) compared to one or more predetermined thresholds and/or using one or more rules. In examples, a user may be evaluated according to a reliability metric (e.g., associated with whether or how often the user successfully completes transactions, for example by having one or more resources available with which to transact).

Accordingly, if it is determined that the user is stable, flow branches “YES” to operation 610, where the transaction is processed according to aspects discussed below with respect to method 770 of FIG. 7C. As a result of processing the transaction according to such aspects, an expected timeframe may be provided associated with a preferred transaction route, while a fallback transaction route may ultimately be used in instances where the recipient is experiencing an issue on a send date for the transaction.

Finally, if it is instead determined that the user is not stable, flow branches “NO” to operation 612, where the transaction is processed according to aspects discussed below with respect to method 700 of FIG. 7A. As a result of processing the transaction according to such aspects, an expected timeframe may be provided associated with a fallback transaction route, while a preferred transaction route may ultimately be used so as to complete the transaction in advance of the estimated timeframe where possible.

It will be appreciated that the thresholds and/or rules discussed above may vary on a transaction-by-transaction basis, on a user-by-user basis, or over time, among other examples. For instance, a transaction platform may adjust the thresholds and/or rules to balance transaction expediency with one or more costs associated with processing such transactions (e.g., user risk, recipient risk, cost of using a preferred vs. fallback transaction route, and impact on user perception when transactions are not processed on time).

Additionally, it will be appreciated that while examples are described in the context of linking and a transaction history (e.g., between a sender and a recipient), there may be instances where a transaction is processed without linking, a history, and/or a pre-existing relationship between the user and the recipient. For instance, in an example where a resource is being shipped (e.g., via a shipping network), a sender may not have a pre-existing relationship with a recipient, and the transaction platform may coordinate with one or more shippers to complete delivery of the resource to the recipient on behalf of the sender.

FIG. 7A illustrates an overview of an example method 700 for processing a scheduled transaction according to aspects of the present disclosure. In examples, aspects of method 700 are performed by a transaction platform, such as transaction platform 102 in discussed above with respect to FIG. 1.

Method 700 begins at operation 702, where an indication of a scheduled user transaction is received. For example, the indication may be received from an application of a user computing device, such as application 124 of user computing device 106 in FIG. 1. As another example, the indication result from performing aspects of method 300 discussed above with respect to FIG. 3. As an example, the indication may comprise an indication of one or more resources and a transaction recipient, among other examples. The indication may comprise an indication as to a date that the transaction should be sent or by which the transaction must be completed, among other examples.

At operation 704, an indication of an expected timeframe is provided. For example, a set of transaction rules may be evaluated to identify a transaction route with which to process the transaction, such that an estimate may be determined for the identified transaction route accordingly. As another example, the expected timeframe may be determined based on any of a variety of health information, for example, transaction route health, linking health, or synchronization health. For instance, if a transaction route and/or recipient exhibits a health below a predetermined threshold, an estimate may be provided for a fallback transaction route (e.g., an EBN transaction route or a check transaction route) rather than a preferred transaction route. In some instances, the indication received at operation 702 may specify a date by which the transaction must be completed, such that the date may be used to identify a transaction route and/or provide an expected timeframe accordingly. Thus, it will be appreciated that any of a variety of techniques may be used to provide an expected timeframe.

At operation 706, the transaction is sent using a preferred transaction route. For example, operation 706 may be performed on a date at which the transaction is to be initiated to complete the transaction by a given date. The preferred transaction route need not be a transaction route associated with the expected time frame that was indicated at operation 704. For example, the preferred transaction route may have a lower cost, a quicker processing time, or a higher success rate than a transaction route associated with the expected time frame discussed above with respect to operation 704. In some instances, the preferred transaction route may be used to process the transaction even if it is exhibiting health below a predetermined threshold. The preferred transaction route may be determined according to a set of transaction rules according to aspects described herein.

Flow progresses to determination 708, where it is determined whether the transaction was successful. For example, an indication associated with the transaction route may be received (e.g., from a transaction agent associated therewith or from the transaction recipient). As another example, an indication may be received only in instances where a transaction fails, such that determination 708 may comprise determining whether an indication is received within a predetermined amount of time.

If it is determined that the transaction was successful, flow branches “YES” to operation 710, where an indication of a successful transaction is provided. For example, the indication may comprise confirmation information (e.g., a confirmation number, a date when the transaction was completed, and/or information associated with the transaction route). The indication may be provided using any of a variety of techniques, such as to an application of a user computing device or as an electronic communication, among other examples. In some examples, the transaction may have been completed earlier than the expected timeframe that was indicated at operation 704. For example, as a result of being able to use the preferred transaction route, an improved user experience may be provided and/or a lower cost may be incurred by the transaction platform, among other benefits. Method 700 terminates at operation 710.

If, however, it is determined that the transaction was not successful, flow instead branches “NO” to operation 712, where a transaction update is provided to the user. The transaction update may be provided using any of a variety of techniques, such as to an application of a user computing device or as an electronic communication, among other examples. For example, the transaction update may comprise an indication that the transaction will be completed within the expected timeframe that was indicated at operation 704, as may be the case when operation 706 would have otherwise permitted the transaction to be completed early. In other instances, the transaction update may comprise an indication of an updated estimated completion date.

Flow progresses to operation 714, where the transaction is performed using a fallback transaction route. In examples, the fallback transaction route may be determined using a set of transaction rules according to aspects described herein. In other examples, the fallback transaction route may be a route specified by the user and/or the transaction platform. Thus, it will be appreciated that any of a variety of techniques may be used to determine a fallback transaction route via which to send the transaction. While method 700 is discussed in an example where a preferred transaction route and a fallback transaction route may be used, it will be appreciated that any number of fallback routes may be used. For example, as a result of performing a similar determination as discussed above with respect to the fallback route, a second fallback route may be identified for transaction processing, and so on. Flow terminates at operation 714.

FIG. 7B illustrates an overview of another example method 730 for processing a scheduled transaction according to aspects of the present disclosure. In examples, aspects of method 730 are performed by a transaction platform, such as transaction platform 102 in discussed above with respect to FIG. 1.

Method 730 begins at operation 732, where an indication of a scheduled user transaction is received. For example, the indication may be received from an application of a user computing device, such as application 124 of user computing device 106 in FIG. 1. As another example, the indication result from performing aspects of method 300 discussed above with respect to FIG. 3. As an example, the indication may comprise an indication of one or more resources and a transaction recipient, among other examples. The indication may comprise an indication as to a date that the transaction should be sent or by which the transaction must be completed, among other examples.

At determination 734, it is determined whether there is an issue associated the transaction recipient. For example, any of a variety of health information may be evaluated, such as transaction route health, linking health, or synchronization health. For instance, health information may be evaluated with respect to a predetermined threshold, where health information that exceeds the predetermined threshold is determined to indicate there is an issue associated with the transaction recipient. In examples, determination 734 is performed contemporaneously with receipt of the indication to schedule a transaction. Thus, an indication provided at operation 736 or 738 may effectively be a forecast of route availability for when the transaction is ultimately processed.

Accordingly, flow may branch “YES” to operation 736, where an indication of a preferred timeframe is provided. For example, the indication may be based on a preferred transaction route identified as a result of evaluating a set of transaction rules. By contrast, if it is instead determined that the transaction recipient is not healthy, flow branches “NO” to operation 738, where an indication of a fallback timeframe is provided (e.g., as may be determined as a result of evaluating a set of transaction rules). Thus, an indication of an expected timeframe may be provided for either a preferred transaction route (e.g., at operation 736) or a fallback transaction route (e.g., at operation 738).

Flow then either progresses from operation 736 to operation 740 or from operation 738 to operation 740, where the transaction is processed using a preferred transaction route. In examples, operation 740 is performed on a send date associated with the transaction (e.g., such that the transaction is completed by a transaction due date). For example, the preferred transaction route may have a lower cost, a quicker processing time, or a higher success rate than a fallback route. The preferred transaction route may be determined according to a set of transaction rules according to aspects described herein. Thus, even in instances where a fallback timeframe is provided (e.g., via operation 738), the preferred route may be used so as to achieve more expedient processing and/or processing having a lower associated cost, among other examples. In such an example, the preferred route may be used on or prior to a date on which the fallback transaction route would otherwise have been used (e.g., as may be the case when the fallback transaction route has a longer associated processing time).

Flow progresses to determination 742, where it is determined whether the transaction was successful. For example, an indication associated with the transaction route may be received (e.g., from a transaction agent associated therewith or from the transaction recipient). As another example, an indication may be received only in instances where a transaction fails, such that determination 742 may comprise determining whether an indication is received within a predetermined amount of time.

If it is determined that the transaction was successful, flow branches “YES” to operation 744, where an indication of a successful transaction is provided. For example, the indication may comprise confirmation information (e.g., a confirmation number, a date when the transaction was completed, and/or information associated with the transaction route). The indication may be provided using any of a variety of techniques, such as to an application of a user computing device or as an electronic communication, among other examples. In some examples, the transaction may have been completed prior to an expected timeframe that was indicated at operation 738 and may therefore be earlier than a due date for the transaction. For example, as a result of being able to use the preferred transaction route, an improved user experience may be provided. Method 730 terminates at operation 744.

If, however, it is determined that the transaction was not successful, flow instead branches “NO” to operation 746, where the transaction is performed using a fallback transaction route (e.g., an EBN transaction route or a check transaction route). In examples, the fallback transaction route may be determined using a set of transaction rules according to aspects described herein. In other examples, the fallback transaction route may be a route specified by the user and/or the transaction platform. Thus, it will be appreciated that any of a variety of techniques may be used to determine a fallback transaction route via which to send the transaction.

Accordingly, at determination 748, it is determined whether a fallback timeframe was indicated (e.g., as a result of performing operation 738 rather than operation 736). If it is determined that the fallback timeframe was indicated, flow branches “YES” and terminates at operation 744, which was discussed above. Thus, as a result of performing operations 740-746, a transaction may be completed early using the preferred transaction route. Further, use of the fallback transaction route may enable timely transaction processing even in instances where the preferred transaction route was not successful.

However, if it was determined that the fallback timeframe was not indicated (e.g., such that a preferred timeframe was indicated), a transaction update may instead be provided to the user at operation 750. In such an example, the transaction update may comprise an indication that the transaction was processed later than indicated (e.g., as a result of using the fallback transaction route rather than the preferred transaction route). While example timing and associated indications are discussed, it will be appreciated that any of a variety of alternative timings and/or associated indications may be used in other examples. Method 730 terminates at operation 750.

FIG. 7C illustrates an overview of another example method 8770 for processing a scheduled transaction according to aspects of the present disclosure. In examples, aspects of method 770 are performed by a transaction platform, such as transaction platform 102 in discussed above with respect to FIG. 1.

Method 770 begins at operation 772, where an indication of a scheduled user transaction is received. For example, the indication may be received from an application of a user computing device, such as application 124 of user computing device 106 in FIG. 1. As another example, the indication result from performing aspects of method 300 discussed above with respect to FIG. 3. As an example, the indication may comprise an indication of one or more resources and a transaction recipient, among other examples. The indication may comprise an indication as to a date that the transaction should be sent or by which the transaction must be completed, among other examples.

At operation 774, an indication of an expected timeframe is provided. For example, the indication may be based on a preferred transaction route identified as a result of evaluating a set of transaction rules. As compared to operation 704 described above with respect to FIG. 7A, operation 774 may be weighted toward attempting to process a transaction via a preferred transaction route rather than a fallback transaction route. Thus, the expected timeframe may be for a preferred transaction route, regardless of whether or even if the preferred transaction route is experiencing an issue. Rather, the preferred transaction route may be used in advance of a transaction due date, such that a resulting issue may be handled accordingly.

At determination 776, it is determined whether there is an issue associated the transaction recipient. For example, any of a variety of health information may be evaluated, such as transaction route health, linking health, or synchronization health. For instance, health information may be evaluated with respect to a predetermined threshold, where health information that exceeds the predetermined threshold is determined to indicate there is an issue associated with the transaction recipient. In examples, determination 776 is performed on a date at which the transaction is to be initiated in order to complete the transaction by a given date (e.g., an associated due date). Thus, if an issue is encountered using the preferred transaction route, the transaction may be processed using a fallback transaction route in time for the transaction to be completed by the given date. As another example, if it is known that a transaction route is or will be undergoing maintenance, a different transaction route may be used accordingly.

Accordingly, if it is determined that there is an issue associated with the transaction recipient, flow branches “YES” to operation 778, where the transaction is processed using a fallback transaction route (e.g., an EBN transaction route or a check transaction route). In examples, the fallback transaction route may be determined using a set of transaction rules according to aspects described herein. In other examples, the fallback transaction route may be a route specified by the user and/or the transaction platform. Thus, it will be appreciated that any of a variety of techniques may be used to determine a fallback transaction route via which to send the transaction. As noted above, the transaction may be completed on time even if the expected timeframe provided at operation 774 is different than the timeframe ultimately achieved via the fallback transaction route. Flow terminates at operation 778.

By contrast, if an issue associated with the transaction recipient is not identified, flow branches “NO” to operation 780, where the transaction is processed using a preferred transaction route. For example, the preferred transaction route may have a lower cost, a quicker processing time, or a higher success rate than the fallback route described above with respect to operation 778. The preferred transaction route may be determined according to a set of transaction rules according to aspects described herein.

Flow progresses to determination 782, where it is determined whether the transaction was successful. For example, an indication associated with the transaction route may be received (e.g., from a transaction agent associated therewith or from the transaction recipient). As another example, an indication may be received only in instances where a transaction fails, such that determination 782 may comprise determining whether an indication is received within a predetermined amount of time.

If it is determined that the transaction was successful, flow branches “YES” to operation 784, where an indication of a successful transaction is provided. For example, the indication may comprise confirmation information (e.g., a confirmation number, a date when the transaction was completed, and/or information associated with the transaction route). The indication may be provided using any of a variety of techniques, such as to an application of a user computing device or as an electronic communication, among other examples. In some examples, the transaction may have been completed by the expected timeframe that was indicated at operation 774, but earlier than a due date for the transaction. For example, as a result of being able to use the preferred transaction route, an improved user experience may be provided. Method 770 terminates at operation 784.

If, however, it is determined that the transaction was not successful, flow instead branches “NO” to operation 786, where a transaction update is provided to the user. The transaction update may be provided using any of a variety of techniques, such as to an application of a user computing device or as an electronic communication, among other examples. For example, the transaction update may comprise an indication that the transaction will be completed after the expected timeframe that was indicated at operation 774 by will still be on time (e.g., by a transaction due date), as may be the case when operation 780 would have otherwise permitted the transaction to be completed early. In other instances, the transaction update may comprise an indication of an updated estimated completion date. Flow progresses to operation 778, where the transaction is performed using a fallback transaction route as described above, after which method 770 terminates.

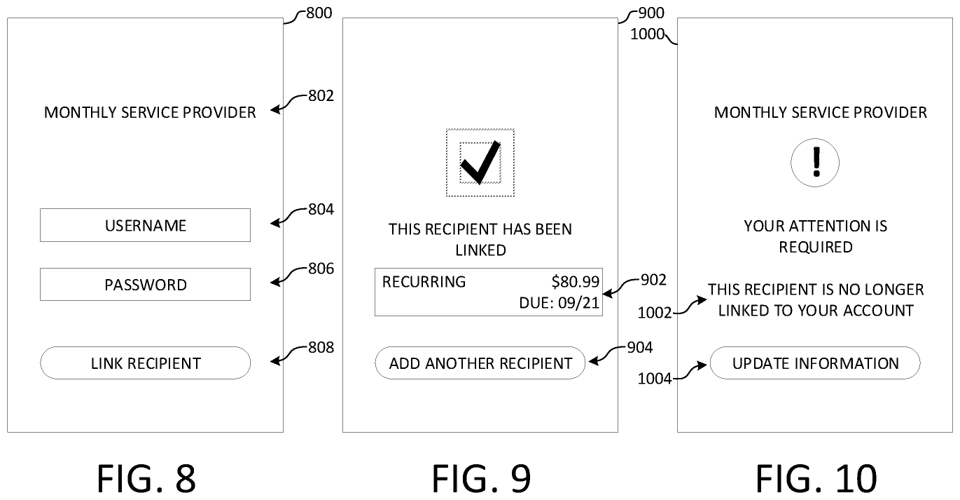

FIG. 8 illustrates an overview of an example user interface 800 for requesting user information associated with a transaction recipient. For example, user interface 800 may be presented to a user as a result of a transaction platform performing aspects of operation 410 discussed above with respect to FIG. 4.

As illustrated, user interface 800 comprises recipient name 802, username field 804, password field 806, and link recipient button 808. In examples, a user may select a transaction recipient from a list of available recipients, at which point user interface 800 is presented. Accordingly, the user may input recipient information associated with the transaction recipient shown in recipient name 802. For example, user interface 800 is illustrated as comprising username field 804 and password field 806 via which the user may input recipient information accordingly. It will be appreciated that a username and password is provided as an example and, in other examples, any of a variety of other recipient information may be received from a user.

Once a user actuates link recipient button 808, a transaction platform may communicate with the transaction recipient to establish a link with the recipient according to aspects described herein. For example, aspects of method 300 described above with respect to FIG. 3 may be performed. As another example, the recipient information may be received by a transaction platform performing aspects of operation 412 discussed above with respect to FIG. 4.

In examples where a link is successfully established, user interface 900 in FIG. 9 may be presented, which illustrates an overview of an example user interface for providing confirmation of a scheduled transaction. For example, user interface 900 may be presented as a result of a transaction platform performing aspects of operation 406 discussed above with respect to FIG. 4, where transaction information is obtained via a link with a transaction recipient. In a further example, aspects similar to user interface 900 may be presented in association with operation 316 in FIG. 3, where transaction information from a transaction recipient is provided for display to a user, such that user confirmation of the transaction may be received.

As illustrated, user interface 900 comprises an indication 902 of transaction information associated with a recurring transaction. Indication 902 comprises a summary of an associated resource (e.g., “$80.99”) and a due date. User interface 900 further comprises button 904, via which a user may use the transaction platform to establish a link another transaction recipient.

FIG. 10 illustrates an overview of an example user interface 1000 for providing an indication that a transaction recipient is no longer linked with a user account. For example, user interface 1000 may be presented to a user when it was not possible to retrieve transaction information from a transaction recipient (e.g., as discussed above with respect to operation 420 in FIG. 4) or as a result of determining that an account of a user is no longer linked with the transaction recipient (e.g., as a result of determination 504 discussed above with respect to FIG. 5). As another example, a similar user interface may be presented with linking with a transaction fails (e.g., via user interface 800 in FIG. 8).

As illustrated, user interface 1000 comprises warning 1002 and update information button 1004. In examples, warning 1002 may be customized by a transaction recipient, such that a user is presented with a warning associated with the transaction recipient when it is determined that the user is no longer linked to the transaction recipient via the transaction platform. In examples, a user may actuate update information button 1004, in response to which the user may be presented with a user interface with which to enter recipient information. Examples of such aspects were discussed above with respect to user interface 800 in FIG. 8.

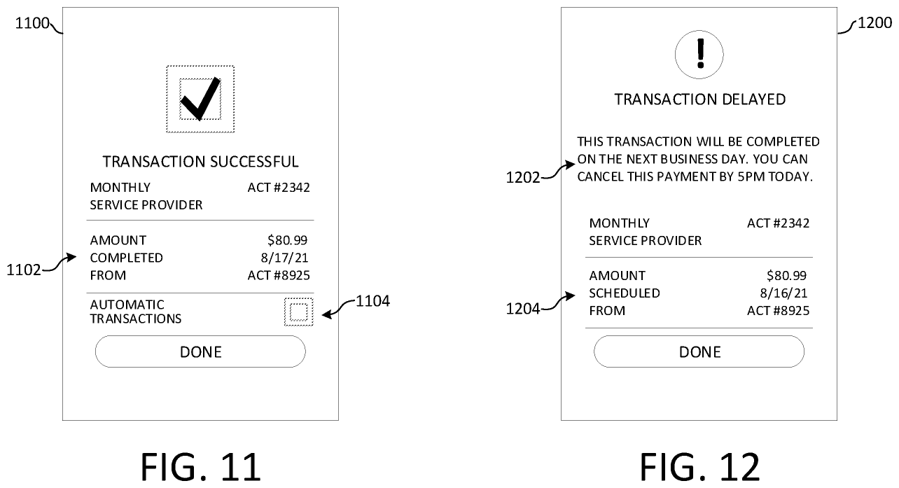

FIG. 11 illustrates an overview of an example user interface 1100 for providing an indication of a successful transaction. For example, user interface 1100 may be presented to a user as a result of a successful transaction, as discussed above with respect to operations 514, 710, 744 or 784 discussed above with respect to FIGS. 5, 7A, 7B, and 7C, respectively.

As illustrated, user interface 1100 comprises confirmation information 1102 and automatic transactions toggle 1104. For example, at least a part of the confirmation information may have been received from a transaction recipient via a transaction platform according to aspects described herein. As illustrated, confirmation information 1102 comprises an indication as to resources associated with the transaction (e.g., “$80.99”), a completion date (e.g., “8/17/21”), and an account from which the transaction resources were transferred (e.g., “ACT #8925”).

In some instances, a user may actuate automatic transactions toggle 1104 to configure recurring or scheduled transactions with a transaction recipient, for example using a link between a user account and the transaction recipient as described above. Automatic transactions toggle 1104 may be omitted or greyed out in certain instances, for example in instances where linking is not available or is not healthy for a transaction recipient.

FIG. 12 illustrates an overview of an example user interface 1200 for providing an indication that a fallback transaction route will be used to complete a transaction. As compared to user interface 1100, user interface 1200 may be presented when a transaction could not be performed via a preferred transaction route. For example, user interface 1200 may be presented to a user as a result of utilizing a fallback transaction route, as discussed above with respect to operations 506, 714, 750, and 778 in FIGS. 5, 7A, 7B, and 7C, respectively.

As illustrated, user interface 1200 comprises warning 1202 and confirmation information 1204. Similar to warning 1002 discussed above with respect to FIG. 10, warning 1202 may be customized by a transaction recipient or a transaction route, such that a user is presented with the warning when it is determined that a transaction should be routed using a fallback transaction route. User interface 1200 further comprises confirmation information 1204, as may be determined via a fallback transaction route used to process the transaction. Aspects of confirmation information 1204 are similar to those discussed above with respect to confirmation information 1102 and are therefore not necessarily re-described in detail.

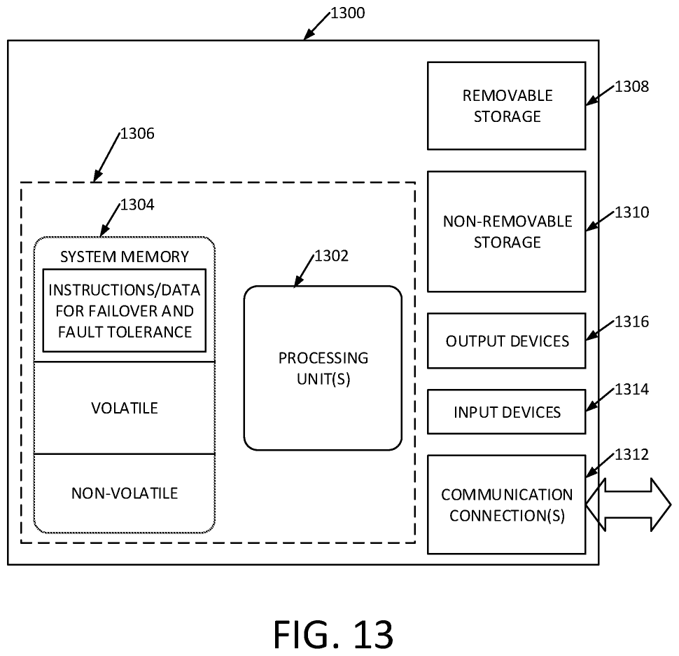

FIG. 13 illustrates an example of a suitable operating environment 1300 in which one or more of the present embodiments may be implemented. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, operating environment 1300 typically may include at least one processing unit 1302 and memory 1304. Depending on the exact configuration and type of computing device, memory 1304 (storing, among other things, APIs, programs, etc. and/or other components or instructions to implement or perform the system and methods disclosed herein, etc.) may be volatile (such as RAM), non-volatile (such as ROM, flash memory, etc.), or some combination of the two. This most basic configuration is illustrated in FIG. 13 by dashed line 1306. Further, environment 1300 may also include storage devices (removable, 1308, and/or non-removable, 1310) including, but not limited to, magnetic or optical disks or tape. Similarly, environment 1300 may also have input device(s) 1314 such as a keyboard, mouse, pen, voice input, etc. and/or output device(s) 1316 such as a display, speakers, printer, etc. Also included in the environment may be one or more communication connections, 1312, such as LAN, WAN, point to point, etc.

Operating environment 1300 may include at least some form of computer readable media. The computer readable media may be any available media that can be accessed by processing unit 1302 or other devices comprising the operating environment. For example, the computer readable media may include computer storage media and communication media. The computer storage media may include volatile and nonvolatile, removable and non-removable media implemented in any method or technology for storage of information such as computer readable instructions, data structures, program modules or other data. The computer storage media may include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium, which can be used to store the desired information. The computer storage media may not include communication media.

The communication media may embody computer readable instructions, data structures, program modules, or other data in a modulated data signal such as a carrier wave or other transport mechanism and includes any information delivery media. The term “modulated data signal” may mean a signal that has one or more of its characteristics set or changed in such a manner as to encode information in the signal. For example, the communication media may include a wired media such as a wired network or direct-wired connection, and wireless media such as acoustic, RF, infrared and other wireless media. Combinations of the any of the above should also be included within the scope of computer readable media.

The operating environment 1300 may be a single computer (e.g., a mobile computing device, a tablet computing device, an Internet-of-Things (IoT) device, a laptop computing device, or a point of sale system) operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

The different aspects described herein may be employed using software, hardware, or a combination of software and hardware to implement and perform the systems and methods disclosed herein. Although specific devices have been recited throughout the disclosure as performing specific functions, one skilled in the art will appreciate that these devices are provided for illustrative purposes, and other devices may be employed to perform the functionality disclosed herein without departing from the scope of the disclosure.

As stated above, a number of program modules and data files may be stored in the system memory 1304. While executing on the processing unit 1302, program modules (e.g., applications, Input/Output (1/O) management, and other utilities) may perform processes including, but not limited to, one or more of the stages of the operational methods described herein such as the methods illustrated in FIG. 2, 3, 4, 5, 6, or 7A-7C, for example.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 13 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the operating environment 1300 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

As will be understood from the foregoing disclosure, one aspect of the technology relates to a system comprising: at least one processor; and memory storing instructions that, when executed by the at least one processor, causes the system to perform a set of operations. The set of operations comprises: accessing transaction completion information associated with a set of transactions of a transaction platform; identifying, based on the transaction completion information, a first categorized subset of transactions from the set of transactions and a second categorized subset of transactions from the set of transactions; generating, based on the first categorized subset of transactions and the second categorized subset of transactions, a transaction rule; and processing a transaction according to the generated transaction rule. In an example, the first categorized subset of transactions comprises a subset of transactions associated with a first transaction route; and the second categorized subset of transactions comprises a subset of transactions associated with a second transaction route. In another example, the generated transaction rule comprises an association with the first transaction route based on determining a first success rate of the first transaction route is higher than a second success rate of the second transaction route; and processing the transaction according to the generated transaction rule comprises processing the transaction using the first transaction route based on the association. In a further example, the first categorized subset of transactions comprises a subset of transactions associated with a first attribute; and the second categorized subset of transactions comprises a subset of transactions associated with a second attribute. In yet another example, the generated transaction rule comprises an association with the first attribute based on determining a first success rate of transactions having the first attribute is higher than a second success rate of transactions having the second attribute; and the transaction is processed according to the generated transaction rule based on determining the transaction has the first transaction attribute. In a further still example, the subset of transaction associated with the first attribute and the subset of transaction associated with the second attribute are both associated with the same transaction route. In another example, the generated transaction rule comprises performing an action of: adding an attribute; removing an attribute; or modifying an attribute; and processing the transaction according to the generated transaction rule comprises adapting the transaction by performing the action to the transaction. In a further example, generating the transaction rule further comprises: determining approval for utilizing the transaction rule to process transactions of the transaction platform. In yet another example, determining approval comprises one or more of: receiving user approval of the generated transaction rule; or approving the generated transaction rule using a machine learning model, wherein the machine learning model was trained according to a set of historical transaction rules.

In another aspect, the technology relates to a method for processing a transaction according to a set of transaction rules. The method comprises: receiving an indication of a transaction between a user and a transaction recipient; providing an indication of an estimated timeframe for the transaction; generating a preferred transaction route for the transaction using the set of transaction rules; processing the transaction using the preferred transaction route; and based on determining that processing the transaction using the preferred transaction route was not successful: processing the transaction using a fallback transaction route. In an example, the estimated timeframe for the transaction is associated with the fallback transaction route. In another example, the method further comprises providing an indication that the transaction was successfully processed according to the estimated timeframe using the fallback transaction route. In a further example, the estimated timeframe for the transaction is associated with the preferred transaction route; and processing the transaction using the preferred transaction route comprises: determining that processing the transaction using the preferred transaction route was not successful based on determining a health associated with the preferred transaction route is below a predetermined threshold; and providing an updated estimated timeframe for the transaction. In yet another example, at least one transaction rule of the set of transaction rules is a specialized transaction rule associated with the user.

In a further aspect, the technology relates to a method for maintaining transaction rules of a transaction platform. The method comprises: accessing transaction completion information associated with a set of transactions of the transaction platform; identifying, based on the transaction completion information, a first categorized subset of transactions from the set of transactions and a second categorized subset of transactions from the set of transactions; generating, based on the first categorized subset of transactions and the second categorized subset of transactions, a transaction rule; and processing a transaction according to the generated transaction rule. In an example, the first categorized subset of transactions comprises a subset of transactions associated with a first transaction route; and the second categorized subset of transactions comprises a subset of transactions associated with a second transaction route. In another example, the generated transaction rule comprises an association with the first transaction route based on determining a first success rate of the first transaction route is higher than a second success rate of the second transaction route; and processing the transaction according to the generated transaction rule comprises processing the transaction using the first transaction route based on the association. In a further example, the first categorized subset of transactions comprises a subset of transactions associated with a first attribute; and the second categorized subset of transactions comprises a subset of transactions associated with a second attribute. In yet another example, the generated transaction rule comprises an association with the first attribute based on determining a first success rate of transactions having the first attribute is higher than a second success rate of transactions having the second attribute; and the transaction is processed according to the generated transaction rule based on determining the transaction has the first transaction attribute. In a further still example, the subset of transaction associated with the first attribute and the subset of transaction associated with the second attribute are both associated with the same transaction route.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, causes the system to perform a set of operations, the set of operations comprising:
accessing transaction completion information associated with a set of transactions of a transaction platform;
identifying, based on the transaction completion information, a first categorized subset of transactions from the set of transactions and a second categorized subset of transactions from the set of transactions;
generating, based on the first categorized subset of transactions and the second categorized subset of transactions, a transaction rule; and
processing a transaction according to the generated transaction rule.

2. The system of claim 1, wherein:
the first categorized subset of transactions comprises a subset of transactions associated with a first transaction route; and
the second categorized subset of transactions comprises a subset of transactions associated with a second transaction route.

3. The system of claim 2, wherein:
the generated transaction rule comprises an association with the first transaction route based on determining a first success rate of the first transaction route is higher than a second success rate of the second transaction route; and
processing the transaction according to the generated transaction rule comprises processing the transaction using the first transaction route based on the association.

4. The system of claim 1, wherein:
the first categorized subset of transactions comprises a subset of transactions associated with a first attribute; and
the second categorized subset of transactions comprises a subset of transactions associated with a second attribute.

5. The system of claim 4, wherein:
the generated transaction rule comprises an association with the first attribute based on determining a first success rate of transactions having the first attribute is higher than a second success rate of transactions having the second attribute; and
the transaction is processed according to the generated transaction rule based on determining the transaction has the first transaction attribute.

6. The system of claim 4, wherein the subset of transaction associated with the first attribute and the subset of transaction associated with the second attribute are both associated with the same transaction route.

7. The system of claim 1, wherein:
the generated transaction rule comprises performing an action of:
adding an attribute;
removing an attribute; or
modifying an attribute; and
processing the transaction according to the generated transaction rule comprises adapting the transaction by performing the action to the transaction.

8. The system of claim 1, wherein generating the transaction rule further comprises:
determining approval for utilizing the transaction rule to process transactions of the transaction platform.

9. The system of claim 8, wherein determining approval comprises one or more of:
receiving user approval of the generated transaction rule; or
approving the generated transaction rule using a machine learning model, wherein the machine learning model was trained according to a set of historical transaction rules.

10. A method for processing a transaction according to a set of transaction rules, comprising:
receiving an indication of a transaction between a user and a transaction recipient;
providing an indication of an estimated timeframe for the transaction;
generating a preferred transaction route for the transaction using the set of transaction rules;
processing the transaction using the preferred transaction route; and
based on determining that processing the transaction using the preferred transaction route was not successful:
processing the transaction using a fallback transaction route.

11. The method of claim 10, wherein the estimated timeframe for the transaction is associated with the fallback transaction route.

12. The method of claim 11, further comprising providing an indication that the transaction was successfully processed according to the estimated timeframe using the fallback transaction route.

13. The method of claim 10, wherein:
the estimated timeframe for the transaction is associated with the preferred transaction route; and
processing the transaction using the preferred transaction route comprises:
determining that processing the transaction using the preferred transaction route was not successful based on determining a health associated with the preferred transaction route is below a predetermined threshold; and
providing an updated estimated timeframe for the transaction.

14. The method of claim 10, wherein at least one transaction rule of the set of transaction rules is a specialized transaction rule associated with the user.

15. A method for maintaining transaction rules of a transaction platform, comprising:
accessing transaction completion information associated with a set of transactions of the transaction platform;
identifying, based on the transaction completion information, a first categorized subset of transactions from the set of transactions and a second categorized subset of transactions from the set of transactions;
generating, based on the first categorized subset of transactions and the second categorized subset of transactions, a transaction rule; and
processing a transaction according to the generated transaction rule.

16. The method of claim 15, wherein:
the first categorized subset of transactions comprises a subset of transactions associated with a first transaction route; and
the second categorized subset of transactions comprises a subset of transactions associated with a second transaction route.

17. The method of claim 16, wherein:
the generated transaction rule comprises an association with the first transaction route based on determining a first success rate of the first transaction route is higher than a second success rate of the second transaction route; and
processing the transaction according to the generated transaction rule comprises processing the transaction using the first transaction route based on the association.

18. The method of claim 15, wherein:
the first categorized subset of transactions comprises a subset of transactions associated with a first attribute; and
the second categorized subset of transactions comprises a subset of transactions associated with a second attribute.

19. The method of claim 18, wherein:
the generated transaction rule comprises an association with the first attribute based on determining a first success rate of transactions having the first attribute is higher than a second success rate of transactions having the second attribute; and
the transaction is processed according to the generated transaction rule based on determining the transaction has the first transaction attribute.

20. The method of claim 18, wherein the subset of transaction associated with the first attribute and the subset of transaction associated with the second attribute are both associated with the same transaction route.
